(19) United States
(12) Patent Application Publication
(10) Pub. No.: US 2023/0418678 A1
(43) Pub. Date: Dec. 28, 2023

(54) CLOUD SYSTEM

(71) Applicant: KYOCERA Document Solutions Inc., Osaka-shi (JP)

(72) Inventors: Masato TANBA, Osaka-shi (JP); Masatomo OSAKA, Osaka-shi (JP)

(21) Appl. No.: 18/213,935

(22) Filed: Jun. 26, 2023

(30) Foreign Application Priority Data
Jun. 28, 2022 (JP) 2022-103677
Jun. 28, 2022 (JP) 2022-103678

(51) Int. Cl. G06F 9/50

(52) U.S. Cl. CPC G06F 9/5072; G06F 9/5011

(57) ABSTRACT

A tenant management system includes an image processing system that executes storage processing that is processing of storing image data or document data received from outside in a storage service or a database service, a cloud control portion that executes scale-out of the image processing system, and a database that sets and holds control information used for controlling a server that realizes a portion of the data processing system for a tenant for each tenant and, in accordance with the control information, the cloud control portion makes a reservation for the scale-out of the portion of the image processing system for a tenant and executes the scale-out for each tenant.

### INCORPORATION BY REFERENCE

This application is based upon, and claims the benefit of priority from, corresponding Japanese Patent Application No. 2022-103677 and Japanese Patent Application No. 2022-103678 filed in the Japan Patent Office on Jun. 28, 2022, the entire contents of which are incorporated herein by reference.

### BACKGROUND

### Field of the Invention

The present disclosure relates to a cloud system built on a cloud.

### Description of Related Art

Typically, as a cloud system built on a cloud, a tenant management system based on a multi-tenant model is known, in which an environment and data for each customer are separated by tenant identification information.

### SUMMARY

A cloud system according the present disclosure includes a data storage system that executes storage processing that is processing of storing data received from outside in a specific location, a cloud control portion that executes scale-out of the data storage system, and a database that sets and holds control information used for controlling a server that realizes a portion of the data storage system for a tenant for each tenant and, in accordance with the control information, the cloud control portion makes a reservation for the scale-out of the portion of the data storage system for a tenant and executes the scale-out for each tenant.

The cloud system according to the present disclosure is configured such that the control information includes a number of the scale-outs to be executed at a time that has been set for each tenant and the cloud control portion makes a reservation for the scale-out whose scheduled time is a specific time after a start time of a period in which a number of times of the storage processing per unit time is larger than a specific number obtained based on the control information for each tenant, based on a history of the storage processing executed by the data storage system.

### BRIEF DESCRIPTION OF THE DRAWINGS

FIG. 1 is a diagram illustrating a tenant managed by a tenant management system included in a system according to one embodiment of the present disclosure.

FIG. 2 is a block diagram of a software configuration of the system according to one embodiment of the present disclosure.

FIG. 3 is a block diagram of a hardware configuration of the system illustrated in FIG. 2.

FIG. 4 is a table illustrating an example of a tenant management table illustrated in FIG. 2.

FIG. 5 is a table illustrating an example of a storage processing management table illustrated in FIG. 2.

FIG. 6 is a table illustrating an example of a setting table illustrated in FIG. 2.

FIG. 7 is a table illustrating an example of a scale-out reservation table illustrated in FIG. 2.

FIG. 8 is a sequence diagram of an operation of the system illustrated in FIG. 2 when a session is established between a user terminal application and a tenant specific application.

FIG. 9 is a sequence diagram of an operation of the system illustrated in FIG. 2 when at least one of image data and document data is transmitted from the user terminal application to an image processing system.

FIG. 10 is a flowchart of an operation of a cloud control portion illustrated in FIG. 2 when executing scale-out processing.

FIG. 11 is a flowchart of an operation of the cloud control portion illustrated in FIG. 2 when executing scale-in processing.

FIG. 12 is a flowchart of an operation of the cloud control portion illustrated in FIG. 2 when executing timeout processing.

FIG. 13 is a flowchart of an operation of the cloud control portion illustrated in FIG. 2 when reserving scale-out of the image processing system.

FIG. 14 is a flowchart of reservation processing illustrated in FIG. 13.

FIG. 15 is a flowchart of an operation of the cloud control portion illustrated in FIG. 2 when executing scale-out of the image processing system, based on a reservation.

### DETAILED DESCRIPTION

Embodiments of the present disclosure will be described below with reference to the accompanying drawings.

First, a configuration of a system according to one embodiment of the present disclosure will be described.

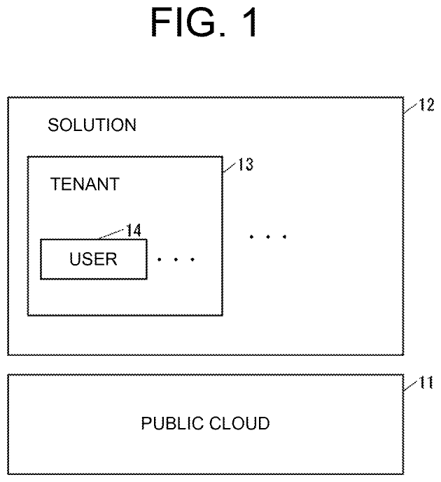

FIG. 1 is a diagram illustrating a tenant managed by a tenant management system included in the system according to this embodiment.

As illustrated in FIG. 1, a solution 12 is built on a public cloud 11. Herein, as the solution 12, for example, a document management solution that manages documents can be employed.

A provider of the solution 12 can let others use at least a portion of the solution 12. A unit in which the provider of the solution 12 lets others use at least a portion of the solution 12 is called a tenant. The solution 12 can have a plurality of tenants including a tenant 13 or the like.

The tenant 13 can have a plurality of users, such as a user 14 or the like.

A configuration of some other tenant than the tenant 13 is similar to that of the tenant 13.

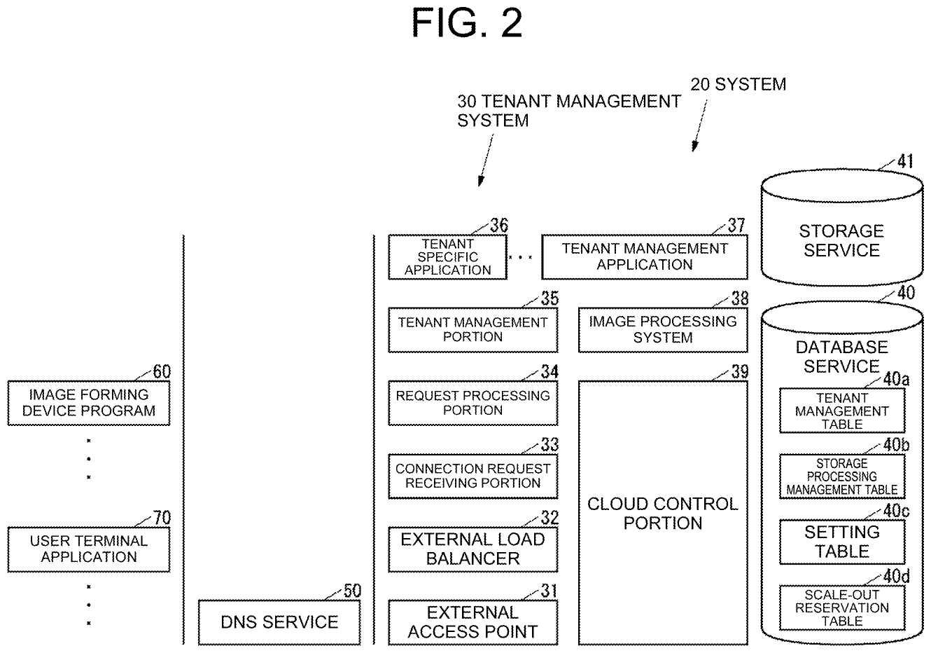

FIG. 2 is a block diagram of a software configuration of a system 20 according to this embodiment.

As illustrated in FIG. 2, the system 20 includes a tenant management system 30 as a cloud system, a domain name system (DNS) service 50 that is a service used for registering fully qualified domain names (FQDNs) of external access points 31 that will be described later, an image forming device program, such as an image forming device program 60 or the like, that is a program to be executed by an image forming device that will be described later, and a user terminal application, such as a user terminal application 70 or the like, that is an application to be executed by a user terminal that will be described later.

The image forming device program is a program that transmits at least one of image data and document data to an image processing system 38 that will be described later in the tenant management system 30 and executes printing based on at least one of the image data and the document data received from the image processing system 38.

The user terminal application is an application that transmits at least one of the image data and the document data to the image processing system 38 that will be described later in the tenant management system 30, receives at least one of the image data and the document data from the image processing system 38, and executes a request for a printing instruction to the image forming device. The user terminal application may be an application that runs on a Web browser.

The tenant management system 30 is a multi-tenant model that separates an environment and data for each customer by tenant identification information. The tenant management system 30 includes, in the public cloud 11 (see FIG. 1), an external access point 31 that is an accessible endpoint opened to outside of the public cloud 11, such as, for example, outside of a data center or the like, an external load balancer 32 that is a service maintaining a connection from outside in accordance with a hypertext transfer protocol (HTTP)/hypertext transfer protocol secure (HTTPS) or the like and realizing a load distribution function of distributing a load to Web servers that will be described later, a connection request receiving portion 33 that is a service receiving a connection request from the external load balancer 32, a request processing portion 34 that is a service processing a request from outside, including a request for authentication, a tenant management portion 35 that is a service causing a tenant specific application that will be described later to receive a request from a user, a tenant specific application, such as a tenant specific application 36 or the like, that is an application prepared for each tenant, a tenant management application 37 that is an application that manages various types of information for a tenant, an image processing system 38 as a data storage system that is a service executing processing (which will be hereinafter referred to as “storage processing”) of performing specific conversion processing, such as processing of converting the at least one of the image data and the document data into data in some other format or like processing, as necessary, storing the at least one of the image data and the document data received from the user terminal application or the like in a specific place, that is, a storage service 41 that will be described later (and also a database service 40, as necessary), and reading the least one of the image data and document data from the storage service 41 (and also from the database service 40, as necessary) in response to a request from the tenant specific application, a cloud control portion 39 that is a service executing scale-out and scale-in of the image processing system 38, the database service 40 that stores a data table, and the storage service 41 that stores at least one of the image data and the document data output by the image processing system 38.

As for the tenant specific application, a plurality of tenant specific applications can be prepared for one tenant. A variety of applications, such as, for example, a document management application, a schedule book application, a chat tool, or he like, can be employed as tenant specific applications.

The database service 40 stores, as data tables, a tenant management table 40a used for managing a tenant, a storage processing management table 40b used for managing storage processing, a setting table 40c indicating a setting for controlling a Web server that realizes the image processing system 38, and a scale-out reservation table 40d used for managing a reservation for scale-out of the image processing system 38.

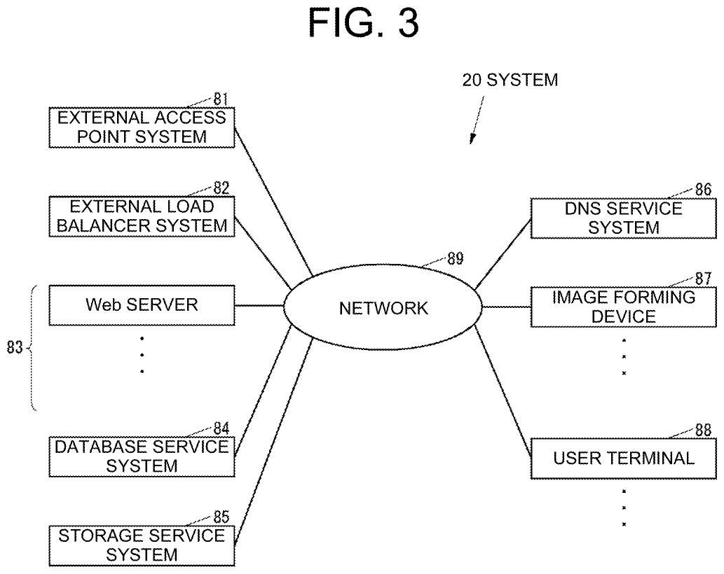

FIG. 3 is a block diagram of a hardware configuration of the system 20.

As illustrated in FIG. 3, the system 20 includes the external access point system 81 that realizes an external access point 31, an external load balancer system 82 that realizes the external load balancer 32, a Web server group 83, a database service system 84 that realizes the database service 40, a storage service system 85 that realizes the storage service 41, a DNS service system 86 that realizes a DNS service 50, an image forming device, such as an image forming device 87 that executes the image forming device program 60, or the like, that executes an image forming device program, and a user terminal, such as a user terminal 88 that executes the user terminal application 70, or the like, that executes a user terminal application. The external access point system 81, the external load balancer system 82, the Web server, the database service system 84, the storage service system 85, the DNS service system 86, the image forming device, and the user terminal can communicate with each other via a network 89, such as the Internet or the like.

Each of the external access point system 81, the external load balancer system 82, the database service system 84, the storage service system 85, and the DNS service system 86 is realized by at least one computer.

The Web server group 83 realizes the connection request receiving portion 33, the request processing portion 34, the tenant management portion 35, the tenant specific application 36, the tenant management application 37, the image processing system 38, and the cloud control portion 39. At least one of the connection request receiving portion 33, the request processing portion 34, the tenant management portion 35, the tenant specific application 36, the tenant management application 37, the image processing system 38, and the cloud control portion 39 may be realized by only one Web server, and may be realized by a plurality of Web servers. At least one Web server of the group 83 may realize at least two of the connection request receiving portion 33, the request processing portion 34, the tenant management portion 35, the tenant specific application 36, the tenant management application 37, and the cloud control portion 39. The image processing system 38 executes storage processing by one Web server for each storage processing.

The image forming device is constituted by, for example, a multifunction peripheral (MFP), a printer-only machine, or the like.

The user terminal is a computer constituted by, for example, a personal computer (PC), a smartphone, or the like.

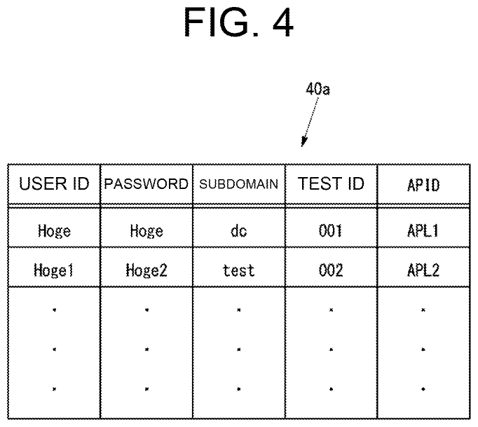

FIG. 4 is a table illustrating an example of the tenant management table 40a.

The tenant management table 40a illustrated in FIG. 4 stores a combination of a user ID as identification information of a user, a password of the user, a subdomain of a tenant, a tenant ID as identification information of the tenants, and an APID as identification information of a tenant specific application. Note that the tenant ID is a three-digit number excluding “000,” for example.

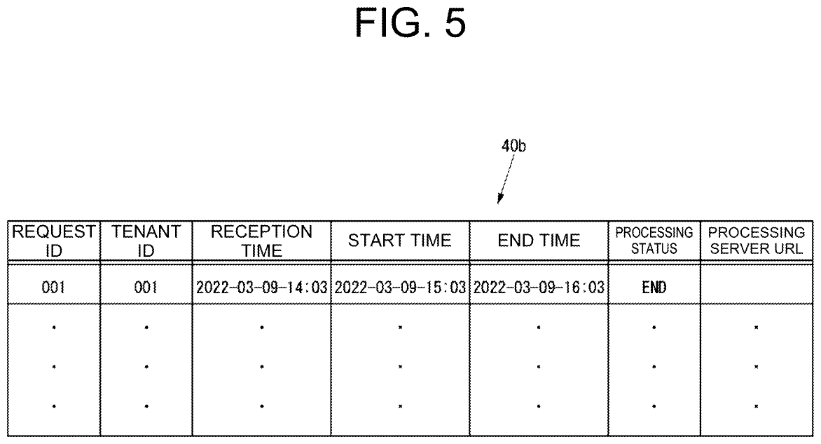

FIG. 5 is a table illustrating an example of the storage processing management table 40b.

The storage processing management table 40b illustrated in FIG. 5 stores a combination of a request ID as identification information of a request for storage processing from a user terminal application, a tenant ID of a tenant to which a user who executed a request for storage processing belongs, a reception time of a request for storage processing from the user terminal application, a start time of storage processing, an end time of storage processing, a processing status indicating a status of storage processing, and a processing server URL indicating a URL of a Web server that executes storage processing among Web servers realizing the image processing system 38. As the processing status, there are “Ready” indicating that storage processing is waiting to be executed, “Processing” indicating that storage processing is under execution, and “End” indicating that execution of storage processing is completed. Note that, although the storage processing management table 40b illustrated in FIG. 5 is depicted without a value of a processing server URL, an URL of a Web server that executes storage processing is entered in an actual situation.

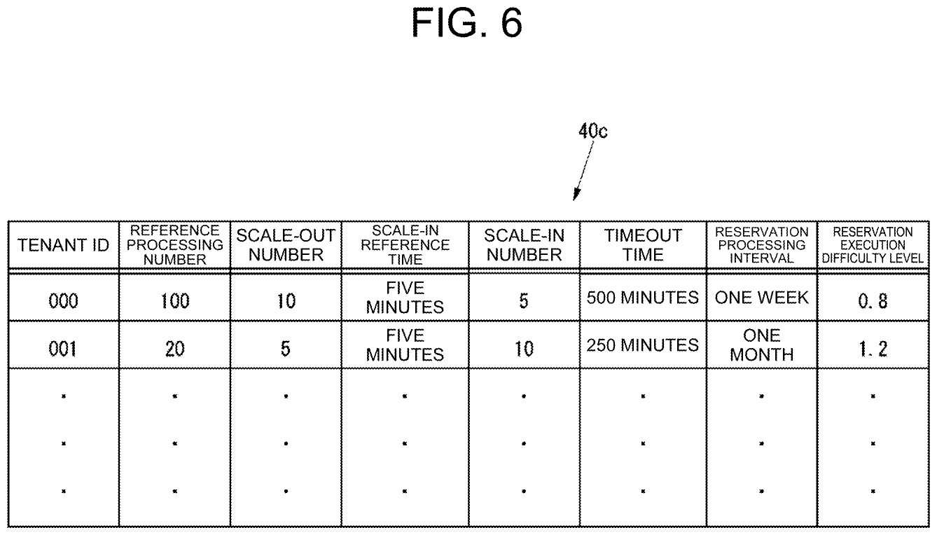

FIG. 6 is a table illustrating an example of the setting table 40c.

The setting table 40c illustrated in FIG. 6 includes a tenant ID of a tenant to which a setting is applied, a reference processing number that serves as a reference for execution of scale-out and scale-in of the image processing system 38 and is set as a number of storage processing under execution, a scale-out number that is set as the number of scale-outs executed at a time by the image processing system 38, a scale-in reference time that is set as a reference time for execution of scale-in of the image processing system 38, a scale-in number that is set as a number of scale-ins executed at a time by the image processing system 38, a timeout time that is set as a time for timeout of storage processing, a reservation processing interval indicating an interval for execution of reservation processing of scale-out of the image processing system 38, and a reservation execution difficulty level indicating a difficulty level of execution of a reservation for scale-out of the image processing system 38. The reservation execution difficulty level is a numeral value of zero or larger and, the larger the numeral value is, the more difficult it is to execute the reservation for scale-out of the image processing system 38. A record with a tenant ID of “000” in the setting table 40c is a record for a tenant whose tenant ID is not specified in the setting table 40c, that is, a record for a reference setting.

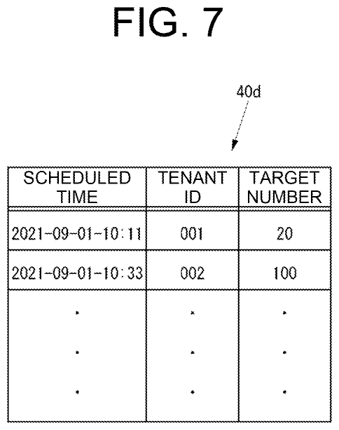

FIG. 7 is a table illustrating an example of the scale-out reservation table 40d.

The scale-out reservation table 40d illustrated in FIG. 7 includes, for each reservation, a scheduled time of reserved scale-out, a tenant ID of a target tenant of the reserved scale-out, and a target number of the reserved scale-out.

Next, an operation of the system 20 will be described.

In the following, as a tenant specific application and a user terminal application, the tenant specific application 36 and the user terminal application 70 will be described respectively, as an example.

First, an operation of the system 20 when a session is established between the user terminal application 70 and the tenant specific application 36 will be described.

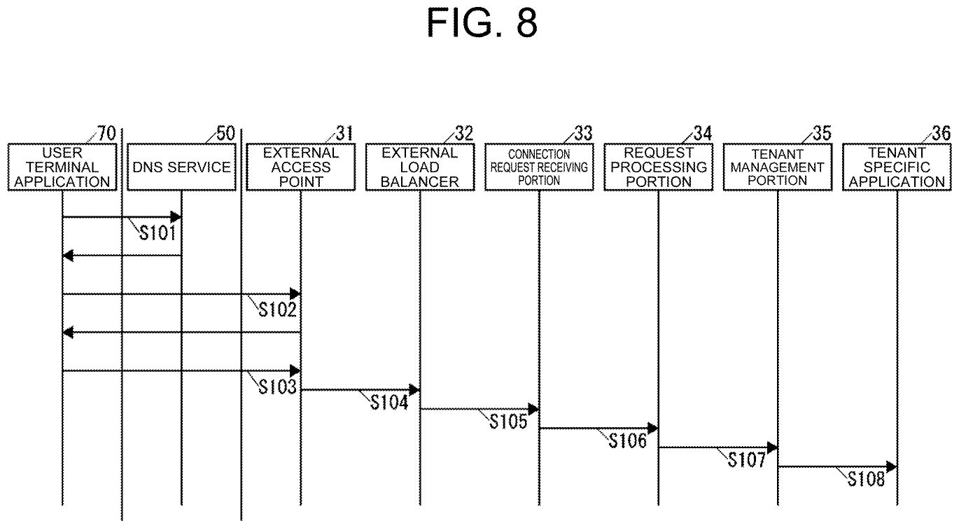

FIG. 8 is a sequence diagram of the operation of the system 20 when a session is established between the user terminal application 70 and the tenant specific application 36.

A user can instruct the user terminal application 70 to use the tenant specific application 36 from the user terminal 88 when the user wishes to use the tenant specific application 36.

Hereafter, it is assumed that a service name, that is, a name of the solution 12 is “service.com.” It is assumed that a domain name of the external access point 31 is “cloud.app.” It is assumed that a subdomain of a tenant (which will be hereinafter referred to as a “target tenant” in description of the operation illustrated in FIG. 8 to FIG. 10) that realizes the tenant specific application 36 is “aap1.”

When the user terminal application 70 is instructed to use the tenant specific application 36, the user terminal application 70 queries the DNS service 50 for a server name of the target tenant by FQDN, that is, “aap1.service.com” (S101), as illustrated in FIG. 8. Herein, the DNS service 50 is registered with a wildcard including the external access point 31, that is, *.cloud.app,” as the server name. Then, when it is assumed that the subdomain is, for example, “XX,” the DNS service 50 returns “XX.cloud.app” in response to a query containing “XX.service.com.” Accordingly, the DNS service 50 returns “aap1.cloud.app” in response to a query including “aap1.service.com.”

After processing of S101, when the server name of the target tenant is returned from the DNS service 50, the user terminal application 70 is connected to the external access point 31 using the server name, that is, “aap1.cloud.app,” returned from the DNS service 50 (S102).

After processing of S102, when the user terminal application 70 is connected to the external access point 31, the user terminal application 70 transmits an HTTP/HTTPS connection request to the external access point 31 (S103). The user terminal application causes the user ID and the password of the user and the subdomain of the target tenant to be included in the HTTP/HTTPS connection request that is transmitted in S103.

When the external access point 31 receives the HTTP/HTTPS connection request transmitted from the user terminal application 70 in S103, the external access point 31 forwards the received HTTP/HTTPS connection request to the external load balancer 32 (S104).

When the external load balancer 32 receives the HTTP/HTTPS connection request forwarded from the external access point 31 in S104, the external load balancer 32 establishes an HTTP/HTTPS connection with the user terminal application 70 and forwards the connection request received from the external access point 31 to the connection request receiving portion 33 (S105). Note that, for an HTTPS connection, the external load balancer 32 terminates a secure sockets layer (SSL).

When the connection request receiving portion 33 receives the connection request forwarded from the external load balancer 32 in S105, the connection request receiving portion 33 forwards the request received from the external access point 31 to the request processing portion 34 (S106).

When the request processing portion 34 receives the request forwarded from the connection request receiving portion 33 in S106, the request processing portion 34 processes an authentication request with the user terminal application 70, based on a combination of the user ID and the password included in the request received from the connection request receiving portion 33, and also acquires the subdomain included in the request received from the connection request receiving portion 33 and calls the tenant management portion 35 (S107). Herein, the request received from the connection request receiving portion 33 includes, for example, a subdomain indicated in HOST of the HTTP REQUEST header.

When the tenant management portion 35 is called by the request processing portion 34 in S107, the tenant management portion 35 calls the tenant specific application 36 designated in the request from the user terminal application 70 among tenant specific applications associated with the subdomain acquired by the request processing portion 34 and the user ID of the user for which authentication has succeeded in the request processing portion 34 in the tenant management table 40a (S108).

In the above-described manner, the session between the user terminal application 70 and the tenant specific application 36 is established. When the session between the user terminal application 70 and the tenant specific application 36 is established, transmission of a request from the user terminal application 70 to the tenant specific application 36 using REST API is enabled.

Next, an operation of the system 20 when at least one of the image data and the document data is transmitted from the user terminal application 70 to the image processing system 38 will be described.

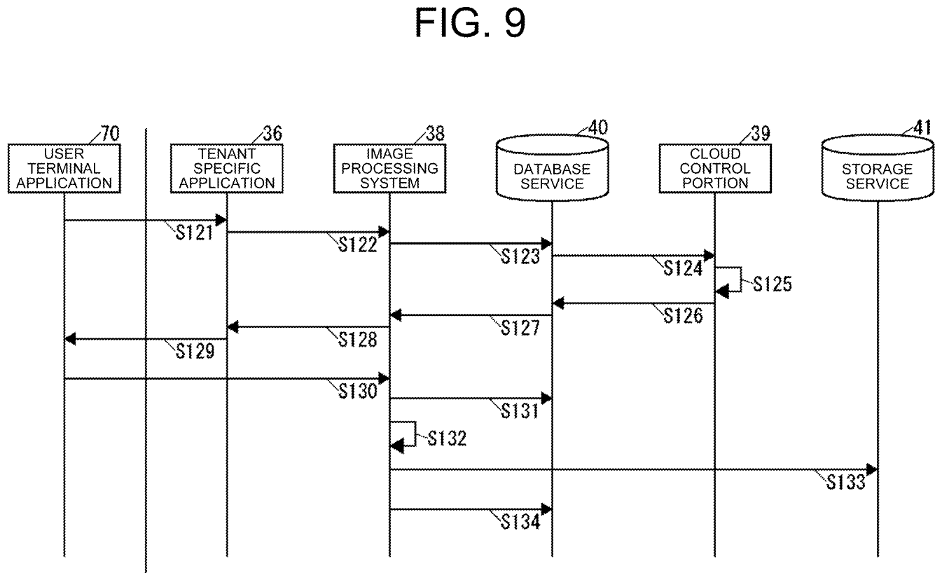

FIG. 9 is a sequence diagram of the operation of the system 20 when at least one of the image data and the document data is transmitted from the user terminal application 70 to the image processing system 38.

When the session between the user terminal application 70 and the tenant specific application 36 is established, the user can instruct the user terminal application to perform storage processing on at least one of image data and document data (which will be hereinafter referred to as “transmission data” in description of the operation illustrated in FIG. 9) from the user terminal 88.

When the user terminal application 70 is instructed to perform storage processing for the transmission data, the user terminal application 70 requests the tenant specific application 36 to transmit the transmission data (S121), as illustrated in FIG. 9.

When the tenant specific application 36 is requested to transmit the transmission data by the user terminal application 70 in S121, the tenant specific application 36 declares a start of transmission of the transmission data to the image processing system 38 (S122).

When the start of transmission of transmission data is declared by the tenant specific application 36 in S122, the image processing system 38 creates a new record in the storage processing management table 40b on the database service 40 (S123). Herein, the image processing system 38 sets a request ID, a tenant ID, a reception time, and a processing status in the new record. For example, the image processing system 38 sets a request ID that has not yet been used in the storage processing management table 40b as a request ID in the new record. The image processing system 38 also sets, as the tenant ID in the new record, the tenant ID associated with the target tenant in the tenant management table 40a. The image processing system 38 also sets a current time as the reception time in the new record. The image processing system 38 also sets “Ready” as a processing status in the new record.

After processing of S123, the database service 40 notifies the cloud control portion 39 of update of the storage processing management table 40b (S124). Herein, the database service 40 causes the request ID in the record generated in S123 to be included in a notification in S124.

When the cloud control portion 39 is notified of the update of the storage processing management table 40b by the database service 40 in S124, the cloud control portion 39 executes processing (which will be hereinafter referred to as “scale-out processing”) of executing scale-out of the image processing system 38, as necessary (S125).

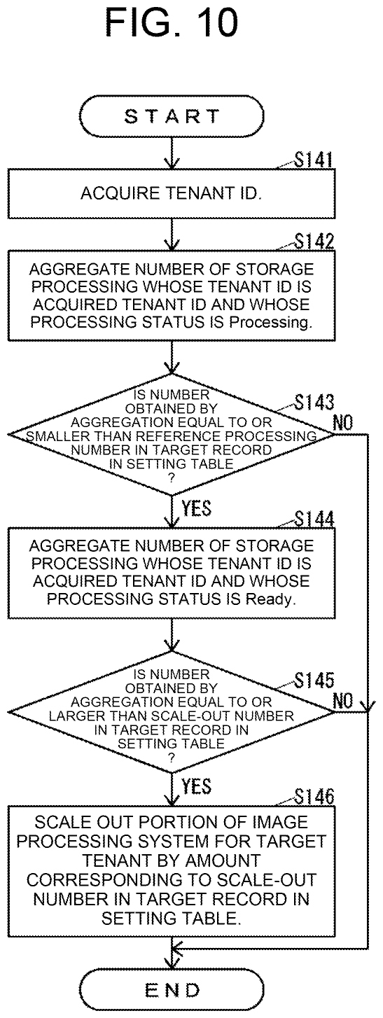

FIG. 10 is a flowchart of an operation of the cloud control portion 39 when executing scale-out processing.

As illustrated in FIG. 10, the cloud control portion 39 acquires the tenant ID in a record corresponding to the request ID notified by the database service 40 in S124 in the storage processing management table 40b (S141).

Next, the cloud control portion 39 aggregates the number of storage processing whose tenant ID is the tenant ID acquired in S141 (which will be hereinafter referred to as an “acquired tenant ID in description of the operation illustrated in FIG. 10) and whose processing status is “Processing” in the storage processing management table 40b (S142).

Next, the cloud control portion 39 determines whether the number obtained by aggregation in S142 is equal to or smaller than a reference processing number in the record corresponding to the acquired tenant ID (which will be hereinafter referred to as a “target record” in the description of the operation illustrated in FIG. 10 in the setting table 40c (S143). Herein, the cloud control portion 39 specifies the record whose tenant ID is “000” as a target record when the acquired tenant ID is not specified as the tenant ID in the setting table 40c.

When the cloud control portion 39 determines in S143 that the number obtained by aggregation in S142 is equal to or smaller than the reference processing number in the target record in the setting table 40c, the cloud control portion 39 aggregates the number of storage processing whose tenant ID is the acquired tenant ID and whose processing status is “Ready” in the storage processing management table 40b (S144).

Next, the cloud control portion 39 determines whether the number obtained by aggregation in S144 is equal to or larger than the scale-out number of in the target record in the setting table 40c (S145).

When the cloud control portion 39 determines in S145 that the number obtained by aggregation in S144 is equal to or larger than the scale-out number in the target record in the setting table 40c, the cloud control portion 39 scales out a portion of the image processing system 38 for the target tenant by an amount corresponding to the scale-out number in the target record in the setting table 40c (S146). That is, the cloud control portion 39 increases a number of Web servers realizing the portion of the image processing system 38 for the target tenant by the amount corresponding to the scale-out number in the target record in the setting table 40c.

When the cloud control portion 39 determines in S143 that the number obtained by aggregation in S142 is not equal to or smaller than the reference processing number in the target record in the setting table 40c, when the cloud control portion 39 determines in S145 that the number obtained by aggregation in S144 is not equal to or larger than the scale-out number in the target record in the setting table 40c, or when processing of S146 is completed, the cloud control portion 39 terminates the scale-out processing illustrated in FIG. 10.

As illustrated in FIG. 9, when the scale-out processing of S125 is completed, the cloud control portion 39 sets a URL of one Web server that is not executing storage processing among the Web servers each realizing a portion of the image processing system 38 for a target tenant as a processing server URL in the record corresponding to the request ID notified by the database service 40 in S124 in the storage processing management table 40b (S126). Herein, when the cloud control portion 39 executes scale-out in the scale-out processing illustrated in FIG. 10 (S146), the cloud control portion 39 sets a URL of any one Web server newly ensured by this scale-out as the processing server URL.

After processing of S126, the database service 40 notifies the image processing system 38 of the processing server URL set in S126 and the request ID in a record for which the processing server URL has been set in S126 (S127). Therefore, the image processing system 38 can execute storage processing by the Web server identified by the processing server URL notified in S127.

When the image processing system 38 is notified of the processing server URL and the request ID by the database service 40 in S127, the image processing system 38 notifies the tenant specific application 36 of the processing server URL and the request ID notified by the database service 40 in S127 (S128).

When the tenant specific application 36 is notified of the processing server URL and the request ID by the image processing system 38 in S128, the tenant specific application 36 notifies the user terminal application 70 of the processing server URL and the request ID notified by the image processing system 38 in S128 (S129).

When the user terminal application 70 is notified of the processing server URL and the request ID by the tenant specific application 36 in S129, the user terminal application 70 transmits transmission data to the Web server identified by the processing server URL notified by the tenant specific application 36 in S129 among the Web servers realizing the image processing system 38 (S130). Herein, the user terminal application 70 causes the request ID notified by the tenant specific application 36 in S129 to be included in transmission in S130.

When the transmission data is transmitted from the user terminal application 70 in S130, the image processing system 38 sets the current time as a start time in a record specified in the storage processing management table 40b by the request ID transmitted from the user terminal application 70 together with the transmission data and changes a processing status in this record to “Processing” (S131). That is, the image processing system 38 records a start of execution of storage processing in the storage processing management table 40b.

After processing of S131, the image processing system 38 performs specific conversion processing on the transmission data transmitted from the user terminal application 70 in S130, as necessary (S132). Examples of the conversion processing performed in S132 include, for example, processing of converting an image format of transmission data when the transmission data is image data. For example, examples of processing of converting an image format of transmission data include processing of converting the transmission data into portable document format (PDF) data with a full-text search function when the transmission data is joint photographic experts group (JPEG) data. Examples of the conversion processing performed in S132 include, for example, optical character recognition (OCR) in which character information is extracted from transmission data when the transmission data is image data. In addition, examples of the conversion processing performed in S132 include, for example, indexing in which a keyword is extracted from transmission data when the transmission data is PDF data. The conversion processing performed in S132 is designated by the user via the user terminal application 70. Note that the conversion processing in S132 may be omitted.

After the processing of S132, the image processing system 38 stores, when conversion processing is not executed in S132, the transmission data transmitted from the user terminal application 70 in S130 in the storage service 41, and stores, when conversion processing is executed in S132, transmission data after execution of the conversion processing in S132 in the storage service 41 (S133).

Note that the image processing system 38 may configured to store, when the keyword is extracted from transmission data in S132, information, such as the keyword generated in S132 or the like, in the database service 40 in S133. The information stored in S133 in the database service 40 in S133 is used, for example, for search for at least one of the image data and the document data stored in the storage service 41.

After processing of S133, the image processing system 38 sets the current time as an end time in a record specified in the storage processing management table 40b by the request ID transmitted with the transmission data from the user terminal application in S130, and changes a processing status in the record to “End” (S134). That is, the image processing system 38 records an end of execution of the storage processing in the storage processing management table 40b.

In the description above, a case where at least one of the image data and the document data is transmitted from the user terminal application to the image processing system 38 has been described. However, similar is applied to a case where at least one of the image data and the document data is transmitted to the image processing system 38 from the image forming device program.

Next, an operation of the cloud control portion 39 when executing processing of executing scale-in as necessary (which will be hereinafter referred to as “scale-in processing”) will be described.

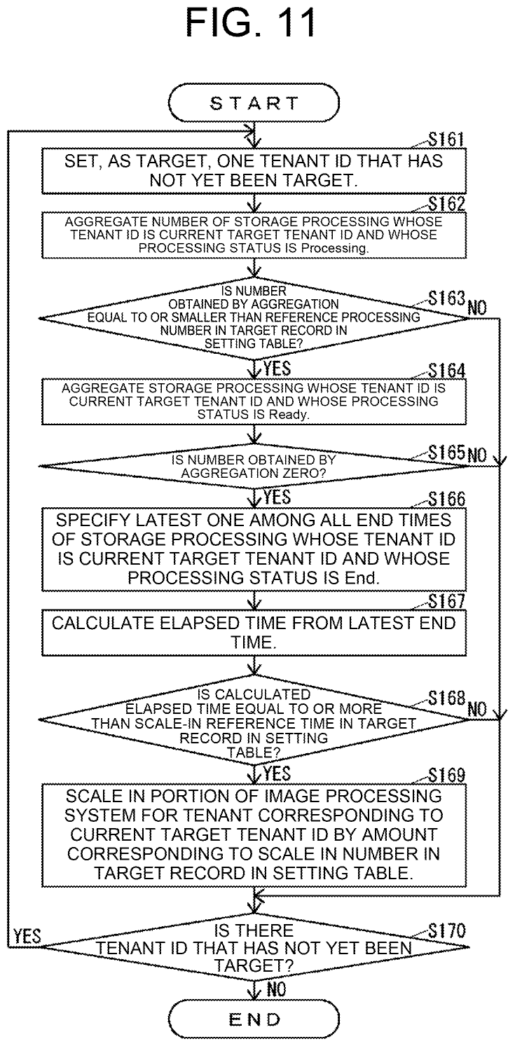

FIG. 11 is a flowchart of the operation of the cloud control portion 39 when executing the scale-in processing.

The cloud control portion 39 executes processing illustrated in FIG. 11 at a periodic timing, for example, every five minutes.

As illustrated in FIG. 11, the cloud control portion 39 sets, as a target, one tenant ID that has not yet been a target in the current operation illustrated in FIG. 11 among tenant IDs indicated in the tenant management table 40a (S161).

Next, the cloud control portion 39 aggregates the number of storage processing whose tenant ID is a current target tenant ID and whose processing status is “Processing” in the storage processing management table 40b (S162).

Next, the cloud control portion 39 determines whether the number obtained by aggregation in S162 is equal to or smaller than the reference processing number in a record corresponding to the current target tenant ID in the setting table 40c (which will be hereinafter referred to as a “target record” in description of the operation illustrated in FIG. 11) (S163). Herein, when the current target tenant ID is not specified as a tenant ID in the setting table 40c, the cloud control portion 39 specifies a record whose tenant ID is “000” as a target record.

When the cloud control portion 39 determines in S163 that the number obtained by aggregation in S162 is equal to or smaller than the reference processing number in the target record in the setting table 40c, the cloud control portion 39 aggregates the number of storage processing whose tenant ID is the current target tenant ID and whose processing status is “Ready” in the storage processing management table (S164).

Next, the cloud control portion 39 determines whether the number obtained by aggregation in S164 is zero (S165).

When the cloud control portion 39 determines in S165 that the number obtained by aggregation in S164 is zero, the cloud control portion 39 specifies a latest one among all end times of storage processing whose tenant ID is the current target tenant ID and whose processing status is “End” in the storage processing management table 40b (S166).

Next, the cloud control portion 39 calculates an elapsed time from a latest end time specified in S166 by subtracting the latest end time specified in S166 from the current time (S167).

Next, the cloud control portion 39 determines whether the elapsed time calculated in S167 is equal to or more than the scale-in reference time in the target record in the setting table 40c (S168).

When the cloud control portion 39 determines in S168 that the elapsed time calculated in S167 is equal to or more than the scale-in reference time in the target record in the setting table 40c, the cloud control portion 39 scales in a portion of the image processing system 38 for a tenant corresponding to the current target tenant ID in the tenant management table 40a by an amount corresponding to the scale-in number in the target record in the setting table 40c (S169). That is, the cloud control portion 39 reduces a number of Web servers realizing the portion of the image processing system 38 for the tenant corresponding to the current target tenant ID in the tenant management table 40a by the amount corresponding to the scale-in number in the target record in the setting table 40c.

When the cloud control portion 39 determines in S163 that the number obtained by aggregation in S162 is not equal to or smaller than the reference processing number in the target record in the setting table 40c, when the cloud control portion 39 determines in S165 that the number obtained by aggregation in S164 is not zero, when the cloud control portion 39 determines in S168 that the elapsed time calculated in S167 is not equal to or more than the scale-in reference time in the target record in the setting table 40c, or when processing of S169 is completed, the cloud control portion 39 determines whether there is a tenant ID that has not yet been a target in the current operation illustrated in FIG. 11 among tenant IDs illustrated in the tenant management table 40a (S170).

When the cloud control portion 39 determines in S170 that, among the tenant IDs indicated in the tenant management table 40a, there is a tenant ID that has not yet been a target in the current operation illustrated in FIG. 11, the cloud control portion 39 executes processing of S161.

When the cloud control portion 39 determines in S170 that, among the tenant IDs indicated in the tenant management table 40a, there is no tenant ID that has not yet been a target in the current operation illustrated in FIG. 11, the cloud control portion 39 terminates the operation illustrated in FIG. 11.

Next, an operation of the cloud control portion 39 when executing processing of stopping the Web server in accordance with the elapsed time from a start time of storage processing under execution (which will be hereinafter referred to as “time-out processing”) will be described.

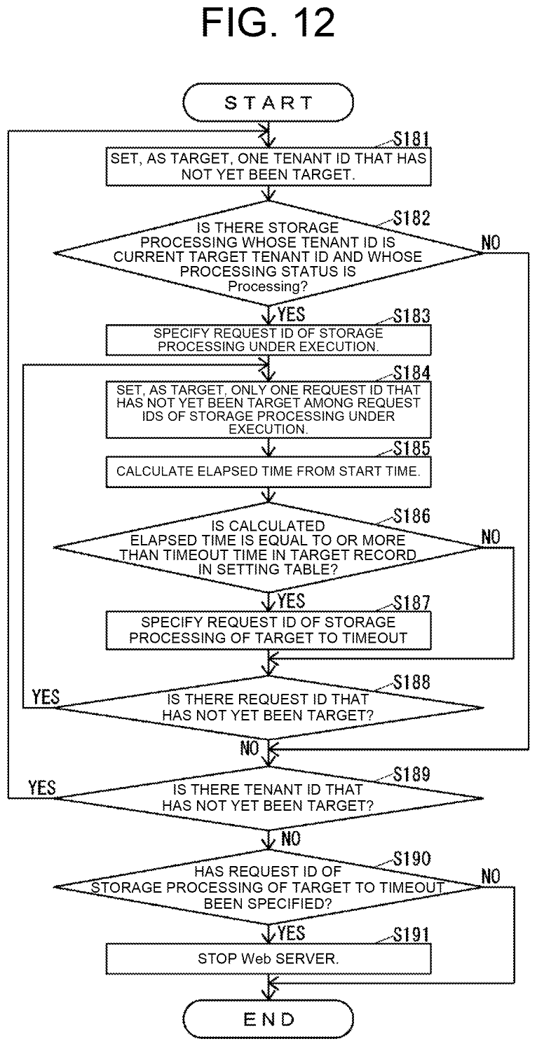

FIG. 12 is a flowchart of the operation of the cloud control portion 39 when executing timeout processing.

The cloud control portion 39 executes the processing illustrated in FIG. 12 at a periodic timing, for example, every five minutes.

As illustrated in FIG. 12, the cloud control portion 39 sets, as a target, one tenant ID that has not yet been a target in the current operation illustrated in FIG. 12 among tenant IDs indicated in the tenant management table 40a (S181).

Next, the cloud control portion 39 determines whether there is storage processing whose tenant ID is the current target tenant ID and whose processing status is “Processing” in the storage processing management table 40b (S182).

When the cloud control portion 39 determines in S182 that there is storage processing whose tenant ID is the current target tenant ID and whose processing status is “Processing” in the storage processing management table 40b, the cloud control portion 39 specifies, as request IDs of storage processing under execution, all request IDs of storage processing whose tenant ID is the current target tenant ID and whose processing status is “Processing” in the storage processing management table 40b (S183).

Next, the cloud control portion 39 sets, as a processing target, only one request ID that has not yet been a processing target in S184 in the current operation illustrated in FIG. 12 among the request IDs of the storage processing under execution specified in S183 (S184).

Next, the cloud control portion 39 calculates an elapsed time from a start time in the storage processing management table 40b for the storage processing specified by the request ID of the current processing target by subtracting the start time in the storage processing management table 40b for the storage processing specified by the request ID of the current processing target from the current time (S185).

Next, the cloud control portion 39 determines whether the elapsed time calculated in S185 is equal to or more than a timeout time in a record corresponding to the tenant ID of the current target tenant in the setting table 40c (which will be hereinafter referred to as a “target record” in the description of the operation illustrated in FIG. 12) (S186).

When the cloud control portion 39 determines in S186 that the elapsed time calculated in S185 is equal to or more than the timeout time in the target record in the setting table 40c, the cloud control portion 39 specifies the request ID of the current processing target as a request ID of storage processing that is a target to timeout (S187).

When the cloud control portion 39 determines in S186 that the elapsed time calculated in S185 is not equal to or more than the timeout time in the target record in the setting table 40c, or when processing of S187 is completed, the cloud control portion 39 determines whether there is a request ID that has not yet been a target in S184 in the current operation illustrated in FIG. 12 among the request IDs of the storage processing under execution specified in S183 (S188).

When the cloud control portion 39 determines in S188 that there is a request ID that has not yet been a target in S184 in the current operation illustrated in FIG. 12 among the request IDs of the storage processing under execution specified in S183, the cloud control portion 39 executes processing of S184.

When the cloud control portion 39 determines in S182 that there is no storage processing whose tenant ID is the current target tenant ID and whose processing status is “Processing” in the storage processing management table 40b or when the cloud control portion 39 determines in S188 that there is no request ID that has not yet been a processing target in S184 in the current operation illustrated in FIG. 12 among the request IDs of the storage processing under execution specified in S183, the cloud control portion 39 determines whether there is a tenant ID that has not yet been a target in the current operation illustrated in FIG. 12 among the tenant IDs indicated in the tenant management table 40a (S189).

When the cloud control portion 39 determines in S189 that there is a tenant ID that has not yet been a target in the current operation illustrated in FIG. 12 among the tenant IDs indicated in the tenant management table 40a, the cloud control portion 39 executes processing of S181.

When the cloud control portion 39 determines in S189 that there is no tenant ID that has not yet been a target in the current operation illustrated in FIG. 12 among the tenant IDs indicated in the tenant management table 40a, the cloud control portion 39 determines whether a request ID of storage processing that is a target to timeout has been specified in S187 in the current operation illustrated in FIG. 12 (S190).

When the cloud control portion 39 determines in S190 that a request ID of the storage processing that is a target to timeout has been specified in S187 in the current operation illustrated in FIG. 12, the cloud control portion 39 stops all Web servers specified by processing server URLs associated with the request ID of the storage processing that is a target to timeout, the request ID having been specified in S187 in the current operation illustrated in FIG. 12, in the storage processing management table (S191).

When the cloud control portion 39 determines in S190 that the request ID of the storage processing that is a target to timeout was not specified in S187 in the current operation illustrated in FIG. 12, or when processing of S191 is completed, the cloud control portion 39 terminates the operation illustrated in FIG. 12.

Note that, in the timeout processing illustrated in FIG. 12, the cloud control portion 39 stops a Web server in which an elapsed time from a start time of execution of storage processing is equal to or more than the timeout time (S191). However, the cloud control portion 39 may be configured to restore an error of the Web server in which the elapsed time from a start time of execution of storage processing is equal to or more than the timeout time, instead of stopping the Web server in which the elapsed time from a start time of execution of storage processing is equal to or more than the timeout time in the timeout processing. Herein, as a method for restoring an error of a Web server, for example, there is a method in which the Web server is restarted.

Next, an operation of the cloud control portion 39 when reserving scale-out of the image processing system 38 will be described.

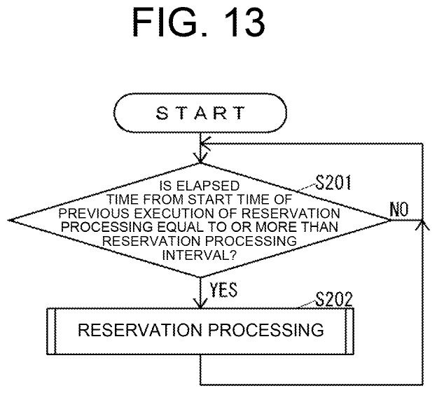

FIG. 13 is a flowchart of the operation of the cloud control portion 39 when reserving scale-out of the image processing system 38.

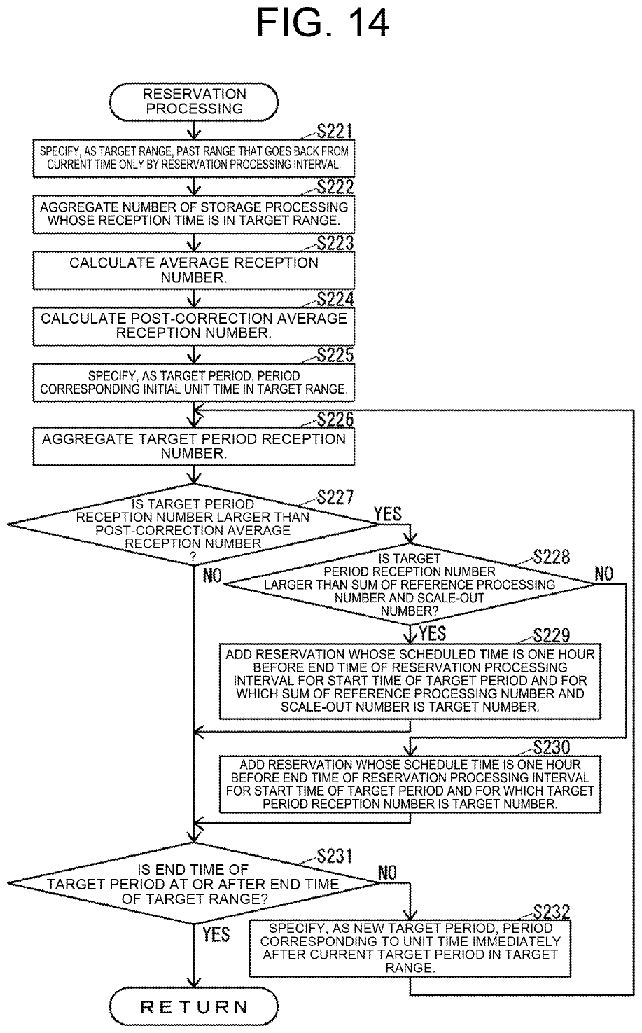

The cloud control portion 39 executes processing illustrated in FIG. 13 for each tenant ID indicated in the tenant management table 40a, that is, for each tenant. In the following description of operations illustrated in FIG. 13 and FIG. 14, a tenant ID that is a target to the operations illustrated in FIG. 13 and FIG. 14 will be referred to as a “target tenant ID” and a tenant corresponding to a target tenant ID in the tenant management table 40a is referred to as a “target tenant.”

As illustrated in FIG. 13, the cloud control portion 39 determines whether an elapsed time from a start time of previous execution of reservation processing for scale-out of a portion of the image processing system 38 for the target tenant is equal to or more than a reservation processing interval in a record (which will be hereinafter referred to as a “target record” in the operations illustrated in FIG. 13 and FIG. 14) corresponding to the target tenant ID in the setting table 40c (S201). Herein, when there is no start time of previous execution of reservation processing for scale-out of a portion of the image processing system 38 for the target tenant, the cloud control portion 39 employs a start time of the operation illustrated in FIG. 13 as the start time of previous execution of reservation processing for scale-out of a portion of the image processing system 38 for the target tenant. When the target tenant ID is not specified as a tenant ID in the setting table 40c, the cloud control portion 39 specifies a record whose tenant ID is “000” as a target record.

When the cloud control portion 39 determines in S201 that the elapsed time from the start time of previous execution of reservation processing for scale-out of a portion of the image processing system 38 for the target tenant is equal to or more than the reservation processing interval in the target record in the setting table 40c, the cloud control portion 39 executes reservation processing for scale-out of the portion of the image processing system 38 for the target tenant (S202).

When the cloud control portion 39 determines in S201 that the elapsed time from the start time of previous execution of the reservation processing for scale-out of a portion of the image processing system 38 for the target tenant is not equal to or more than the reservation processing interval in the target record in the setting table 40c, or when the cloud control portion 39 executes processing of S202, the cloud control portion 39 executes processing of S201.

FIG. 14 is a flowchart of the reservation processing illustrated in FIG. 13.

As illustrated in FIG. 14, the cloud control portion 39 specifies, as a target range, a past range that goes back from the current time by the reservation processing interval in the target record in the setting table 40c (S221).

Next, the cloud control portion 39 aggregates the number of storage processing whose tenant ID is the target tenant ID and whose reception time is in the target range specified in S221 in the storage processing management table 40b (S222).

Next, the cloud control portion 39 calculates an average of the number of receptions for each unit time of storage processing in the target range specified in S221 (which will be hereinafter referred to as an “average reception number”) (S223). Note that, in this embodiment, the unit time is one hour. Accordingly, the cloud control portion 39 calculates the average reception number by dividing the number obtained by aggregation in S222 by the reservation processing interval in the target record in the setting table 40c. For example, when the reservation processing interval in the target record in the setting table 40c is one week, that is, 168 hours, and the number obtained by aggregation in S222 is 1680, then the average reception number calculated in S223 is a value obtained by dividing 1680 by 168, that is, 10.

After processing of S223 is completed, the cloud control portion 39 calculates a number (which will be hereinafter referred to as a “post-correction average reception number”) obtained by multiplying the average reception number calculated in S223 by the reservation execution difficulty level in the target record in the setting table 40c (S224). For example, when the average reception number calculated in S223 is 10 and the reservation execution difficulty level in the target record in the setting table 40c is the post-correction average reception number calculated in S224 is a value obtained by multiplying 10 by 0.8, that is, 8.

After processing of S224 is completed, the cloud control portion 39 specifies a period corresponding to an initial unit time in the target range specified in S221 as a target period (S225).

Next, in the storage processing management table 40b, the cloud control portion 39 aggregates the number of storage processing whose tenant ID is the target tenant ID and whose reception time is in the target period (which will be hereinafter referred to as a “target period reception number”) (S226).

Next, the cloud control portion 39 determines whether the target period reception number obtained by aggregation in S226 is larger than the post-correction average reception number calculated in S224 (S227).

When the cloud control portion 39 determines in S227 that the target period reception number obtained by aggregation in S226 is lager than the post-correction average reception number calculated in S224, the cloud control portion 39 determines whether the target period reception number obtained by aggregation in S226 is lager than a sum of the reference processing number and the scale-out number in the target record in the setting table 40c (S228).

When the cloud control portion 39 determines in S228 that the target period reception number obtained by aggregation in S226 is lager than the sum of the reference processing number and the scale-out number in the target record in the setting table 40c, the cloud control portion 39 adds a reservation whose scheduled time is one hour before an end time of the reservation processing interval in the target record in the setting table for the start time of the target period and whose tenant ID is the target tenant ID and for which the sum of the reference processing number and the scale-out number in the target record in the setting table 40c is a target number to the scale-out reservation table (S229).

When the cloud control portion 39 determines in S228 that the target period reception number obtained by aggregation in S226 is not lager than the sum of the reference processing number and the scale-out number in the target record in the setting table 40c, the cloud control portion 39 adds a reservation whose scheduled time is one hour before the end time of the reservation processing interval in the target record of the setting table 40c for the start time of the target period and whose tenant ID is the target tenant ID and for which the target period reception number obtained by aggregation in S226 is a target number to the scale-out reservation table 40c (S230).

Note that there is a probability that scale-out of the image processing system 38 is not completed in a short time.

Therefore, in order to increase a probability that, for the start time of the target period, proper scale-out of the image processing system 38 has been completed at the end time of the reservation processing interval, the cloud control portion 39 generates, in S229 and S230, a reservation whose schedule time is one hour before the end time of the reservation processing interval for the start time of the target period, not a reservation whose scheduled time is at the end time of the reservation processing interval for the start time of the target period. The “one hour” may be changed to any desired time.

When the cloud control portion 39 determines in S227 that the target period reception number obtained by aggregation in S226 is not lager than the post-correction average reception number calculated in S224, or when processing of S229 or S230 is completed, the cloud control portion 39 determines whether the end time of the target period is at or after the end time of the target range specified in S221 (S231).

When the cloud control portion 39 determines in S231 that the end time of the target period is not at or after the end time of the target range specified in S221, the cloud control portion 39 specifies, as a new target period, a period corresponding to a unit time immediately after the current target period in the target range specified in S221 (S232).

Next, the cloud control portion 39 executes processing of S226.

When the cloud control portion 39 determines in S231 that the end time of the target period is at or after the end time of the target range specified in S221, the cloud control portion 39 terminates the operation illustrated in FIG. 14.

Next, an operation of the cloud control portion 39 when executing scale-out of the image processing system 38, based on a reservation, will be described.

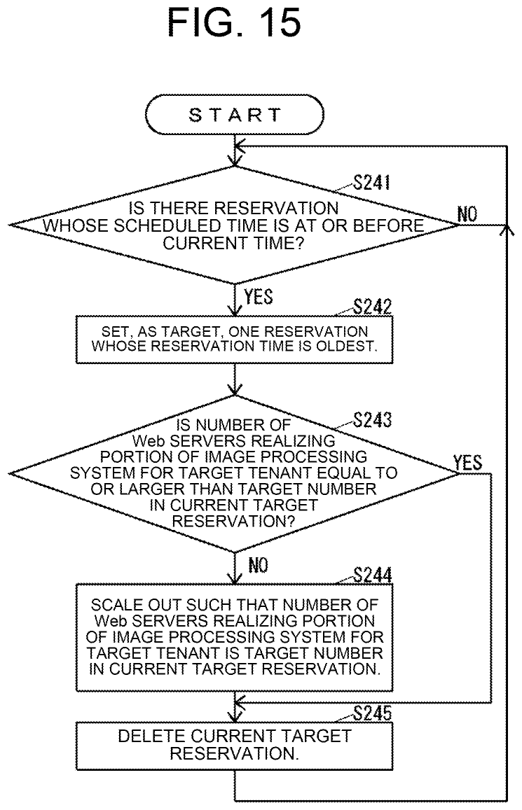

FIG. 15 is a flowchart of the operation of the cloud control portion 39 when executing scale-out of the image processing system 38, based on a reservation.

As illustrated in FIG. 15, the cloud control portion 39 determines whether there is a reservation whose scheduled time is at or before the current time among reservations included in the scale-out reservation table 40d (S241).

When the cloud control portion 39 determines in S241 that there is a reservation whose scheduled time is at or before the current time among the reservations included in the scale-out reservation table 40d, the cloud control portion 39 sets, as a target, one reservation whose scheduled time is oldest among the reservations included in the scale-out reservation table 40d (S242).

Next, the cloud control portion 39 determines whether the number of Web servers realizing a portion of the image processing system 38 for a tenant (which will be hereinafter referred to as a “target tenant” in description of the operation illustrated in FIG. 15) associated with a tenant ID in a current target reservation in the tenant management table 40a is equal to or larger than a target number in the current target reservation (S243).

When the cloud control portion 39 determines in S243 that the number of Web servers realizing the portion of the image processing system 38 for the target tenant is not equal to or larger than the target number in the current target reservation, the cloud control portion 39 scales out the portion of the image processing system 38 for the target tenant such that the number of Web servers realizing the portion of the image processing system 38 for the target tenant is the target number in the current target reservation (S244).

When the cloud control portion 39 determines in S243 that the number of Web servers realizing the portion of the image processing system 38 for the target tenant is equal to or larger than the target number in the current target reservation or when processing of S244 is completed, the cloud control portion 39 deletes the current target reservation from the scale-out reservation table 40d (S245).

When the cloud control portion 39 determines in S241 that there is no reservation whose scheduled time is at or before the current time among the reservations included in the scale-out reservation table 40d or when processing of S245 is completed, the cloud control portion 39 executes processing of S241.

It is highly likely that, in the tenant management system 30, the number of occurrences of storage processing increases as at least one of the number of tenants and the number of the tenant specific applications increases. In addition, in the tenant management system 30, data that is a target of storage processing is at least one of image data and document data, and therefore, a size of the data that is a target of storage processing is large, so that a long time is required for storage processing. Furthermore, in the tenant management system 30, when storage processing includes conversion processing, a long time is required for storage processing. Therefore, in order to reduce a probability that usability is reduced, the tenant management system 30 executes scale-out of the image processing system 38 that executes storage processing as necessary. On the other hand, in order to reduce a probability of increase in cost in the public cloud 11 which charges based on resource usage, the tenant management system 30 executes scale-in of the image processing system 38 as necessary.

The tenant management system 30 executes scale-out processing (S125) before execution of storage processing by the image processing system 38 for each storage processing (S131 to S134), so that a probability that frequency of execution of scale-out of the image processing system 38 is too high or too low can be reduced. Accordingly, the tenant management system 30 can effectively execute scale-out.

The tenant management system 30 does not execute scale-out (S146) of the image processing system 38 when the number of storage processing under execution is equal to or smaller than the reference processing number (NO in S143), and thus, endless execution of scale-out of the image processing system 38 can be prevented. Accordingly, the tenant management system 30 can effectively execute scale-out.

The tenant management system 30 does not execute scale-out (S146) of the image processing system 38 when the number of storage processing waiting to be executed is not equal to or larger than the scale-out number (NO in S145), and thus, it is possible to prevent the tenant management system 30 from executing scale-out of the image processing system 38 although an expected load caused by future execution of storage processing by the image processing system 38 is small. Accordingly, the tenant management system 30 can effectively execute scale-out.

When the number of storage processing under execution is equal to or smaller than the reference processing number (YES in S143) and the number of storage processing waiting to be executed is equal to or larger than the scale-out number (YES in S145), the tenant management system 30 executes scale-out of the image processing system 38 by an amount corresponding to the scale-out number (S146), and thus, when scale-out of the image processing system 38 is needed, the tenant management system can scale out the image processing system 38 by a necessary amount by which the image processing system 38 is needed to be scaled out. Accordingly, the tenant management system 30 can effectively execute scale-out.

The tenant management system 30 is configured such that a maximum number of the Web servers realizing a portion of the image processing system 38 for a tenant, that is, the sum of the reference processing number and the scale out number, can be set for each tenant (see FIG. 6) and executes scale-out of the portion of the image processing system 38 for a tenant for each tenant (S146 and S244), so that the tenant management system 30 can execute scale-out in accordance with the tenant. Therefore, the tenant management system 30 can, for example, meet demands of both a tenant with a large number of times of storage processing and a large processing burden for each storage processing and a tenant with a small number of times of storage processing and a small processing burden for each storage processing, while the entire tenant management system 30 can be efficiently operated.

The tenant management system 30 is configured such that the scale-out number indicating the number of scale-outs executed at a time can be set for each tenant (see FIG. 6), and thus, scale-out can be executed (S146) in accordance with the tenant.

Note that the cloud control portion 39 may be configured to execute scale-out of the image processing system 38 in some other way, instead of or in addition to the methods described above. For example, the cloud control portion 39 may be configured to execute scale-out of the image processing system 38 at some other timing than a “timing before execution of storage processing by the image processing system 38 for each storage processing.”

The tenant management system 30 executes a reservation for scale-out whose scheduled time is a certain amount of time after a start time of a period in which the number (the target period reception number) of storage processing in a unit time is larger than a specific number (the post-correction average reception number) (scheduled time is one hour before an end time of the reservation processing interval), based on a history of storage processing executed by the image processing system 38, that is, the storage processing management table 40b (S229 and S230), and therefore, the tenant management system 30 can execute scale-out that is needed to be periodically executed.

The tenant management system 30 is configured such that each of the reservation processing interval and the reservation execution difficulty level can be set for each tenant (see FIG. 6). The tenant management system 30 executes a reservation for scale-out for each tenant, based on a history of storage processing executed by the image processing system 38 for each tenant, and thus, a reservation for scale-out can be executed in accordance with the tenant.

The tenant management system 30 periodically executes scale-in processing of the image processing system 38 (S161 to S170), and therefore, the tenant management system 30 can execute scale-in of the image processing system 38 at a proper timing. Accordingly, the tenant management system 30 can effectively execute scale-in.

The tenant management system 30 does not execute scale-in of the image processing system 38 (S169) when the number of storage processing under execution is not equal to or smaller than the reference processing number (NO in S163), and thus, a probability that, although the number of storage processing under execution is large, the tenant management system 30 executes scale-in of the image processing system 38 to thus interfere with execution of storage processing can be reduced. Accordingly, the tenant management system 30 can effectively execute scale-in.

The tenant management system 30 does not execute scale-in of the image processing system 38 (S169) when there is storage processing waiting to be executed (NO in S165), and thus, a probability that the tenant management system 30 executes scale-in of the image processing system 38 although there is storage processing waiting to be executed to thus interfere with future execution of storage processing can be reduced. Accordingly, the tenant management system 30 can effectively execute scale-in.

The tenant management system 30 does not execute scale-in of the image processing system 38 (S169) when an elapsed time from an end time of storage processing whose execution has been completed last (NO in S168) is not equal to or more than the scale-in reference time, and thus, a probability that the tenant management system 30 executes scale-in of the image processing system 38 immediately after storage processing is completed to thus interfere with future execution of storage processing can be reduced. Accordingly, the tenant management system 30 can effectively execute scale-in.

The tenant management system 30 executes scale-in of the image processing system 38 by an amount corresponding to the scale-in time (S169) when the elapsed time from the end time of storage processing whose execution has been completed last is equal to or more than the scale-in reference time (YES in S168) in a case where the number of storage processing under execution is equal to or smaller than the reference processing number and there is no storage processing waiting to be executed (YES in S163 and YES in S165), and thus, can scale in the image processing system 38 by a necessary amount by which the image processing system 38 is needed to be scaled in when scale-in of the image processing system 38 is needed. Accordingly, the tenant management system 30 can effectively execute scale-in.

The tenant management system 30 is configured such that each of the reference processing number, the scale-in reference time, and the scale-in number is set for each tenant (see FIG. 6), and thus, can execute scale-in in accordance with the tenant.

Note that the cloud control portion 39 may be configured to execute scale-in of the image processing system 38 in some other way, instead of or in addition to the methods described above. For example, the cloud control portion 39 may be configured to execute scale-in of the image processing system 38 at some other timing than a periodic timing.

There is a probability that, in the tenant management system 30, for example, when a size of at least one of image data and document data as a target of storage processing is too large, when a fault occurs in conversion processing in storage processing, or the like, storage processing is stagnated for a long time. It is highly likely that, in the tenant management system 30, the number of occurrences of storage processing increases as at least one of the number of tenants and the number of the tenant specific applications increases, and thus, when at least one of the number of tenants and the number of the tenant specific applications increases, it is high likely that storage processing is stagnated for long time.

In a case where an elapsed time from a start time of storage processing under execution by a Web server is equal to or more than the timeout time (YES in S186), the tenant management system 30 stops the Web server (S191) or restores an error of the Web server, and thus, when processing is stagnated for a long time in a Web server realizing the image processing system 38, a probability that the tenant management system 38 continues to use the Web server as it is can be reduced. Accordingly, the tenant management system 30 can efficiently use the Web server realizing the image processing system 38.

The tenant management system 30 periodically executes timeout processing for the image processing system 38 (S181 to S191), and thus, can execute timeout processing for the image processing system 38 at an appropriate timing. Accordingly, the tenant management system 30 can efficiently use the Web server realizing the image processing system 38.

The tenant management system 30 is configured such that the timeout time can be set for each tenant (see FIG. 6), and thus, can execute timeout processing (S181 to S191) in accordance with the tenant.

What is claimed is:

1. A cloud system comprising:
a data storage system that executes storage processing that is processing of storing data received from outside in a specific location;
a cloud control portion that makes a reservation for scale-out of the data storage system and executes the scale-out; and
a database that sets and holds control information used for controlling a server that realizes a portion of the data storage system for a tenant for each tenant,
wherein, in accordance with the control information, the cloud control portion makes a reservation for the scale-out of the portion of the data storage system for a tenant and executes the scale-out for each tenant.

2. The cloud system according to claim 1,
wherein the cloud control portion makes a reservation for the scale-out whose scheduled time is a specific time after a start time of a period in which a number of times of the storage processing per unit time is larger than a specific number obtained based on the control information for each tenant, based on a history of the storage processing executed by the data storage system.

3. The cloud system according to claim 1,
wherein the control information includes a number of the scale-outs to be executed at a time that has been set for each tenant and the cloud control portion executes the scale out in accordance with the number of scale-outs to be executed at a time.

4. The cloud system according to claim 1,
wherein the control information includes a maximum number of the servers that realize the portion for a tenant set for each tenant and the cloud control portion executes the scale-out in accordance with the maximum number.

5. The cloud system according to claim 2,
wherein the specific number is based on an average number of the storage processing in the unit time.

6. A cloud system comprising:
a data storage system that executes storage processing that is processing of storing data received from outside in a specific location; and
a cloud control portion that executes a scale-out of the data storage system,
wherein a maximum number of servers that realize a portion of the data storage system for a tenant can be set for each tenant, and
the cloud control portion executes the scale-out of the portion of the data storage system for a tenant for each tenant.

7. The cloud system according to claim 6,
wherein a number of the scale-outs to be executed at a time can be set for each tenant.

8. A cloud system comprising:
a data storage system that executes storage processing that is processing of storing data received from outside in a specific location;
a cloud control portion that executes a scale-out of the data storage system,
wherein the cloud control portion makes a reservation for the scale-out whose scheduled time is a specific time after a start time of a period in which a number of times of the storage processing per unit time is larger than a specific number, based on a history of the storage processing executed by the data storage system.

9. The cloud system according to claim 8,
wherein the cloud control portion makes the reservation for each tenant, based on the history for each tenant.
